(19) United States
(12) Patent Application Publication
(10) Pub. No.: US 2012/0067711 A1
(43) Pub. Date: Mar. 22, 2012

(54) ELECTRONIC DEVICE HAVING WATERPROOF BUTTON

(75) Inventor: SONG-LING YANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 12/960,351

(22) Filed: Dec. 3, 2010

(30) Foreign Application Priority Data
Sep. 16, 2010 (CN) 201010283621.7

(51) Int. Cl. H01H 3/12

(52) U.S. Cl. 200/341

(57) ABSTRACT

An electronic device includes a housing and a button assembly. The housing defines a through hole. The button assembly includes a button, a first sealing frame, a second sealing frame, and a sticking layer. The button includes a button body and a plate. The button body is attached to the plate, extending through the through hole and external to the housing. The plate provides a rebounding force to return the button body. The first sealing frame, the second sealing frame and the sticking layer are made of waterproof material. The first sealing frame seals the housing defining the through hole and the plate, the second sealing frame seals the plate and the sticking layer, the sticking layer covers the through hole and prevents water from entering the housing through the through hole.

### BACKGROUND

1. Technical Field

The present disclosure relates to electronic devices and, particularly, to an electronic device with a waterproof button.

2. Description of Related Art

Electronic devices such as cell phones often include a number of mechanical buttons. Due to the gap between the buttons and the housing of the device, water may penetrate the device and cause damage.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is an isometric view of an electronic device in accordance with an exemplary embodiment.

FIG. 2 is an isometric, partial, exploded view of the electronic device of FIG. 1.

FIG. 3 is an isometric view showing an internal side of a button of the electronic device of FIG. 2.

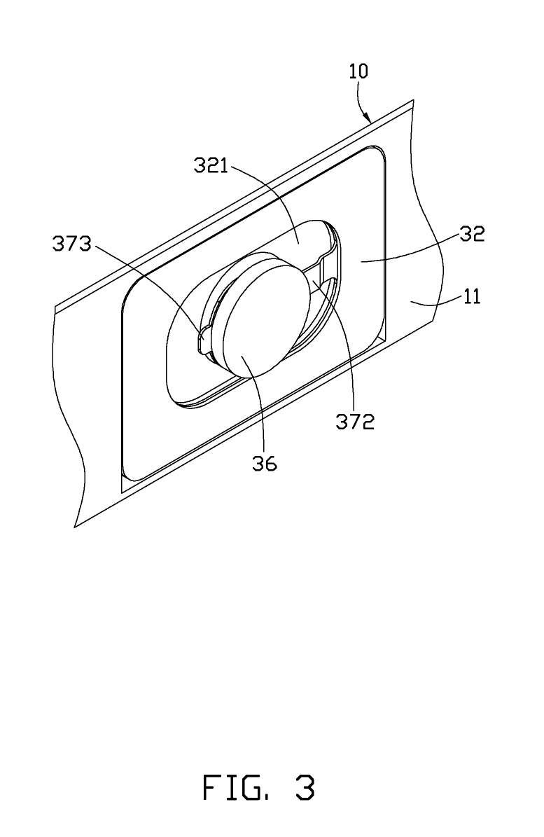

### DETAILED DESCRIPTION

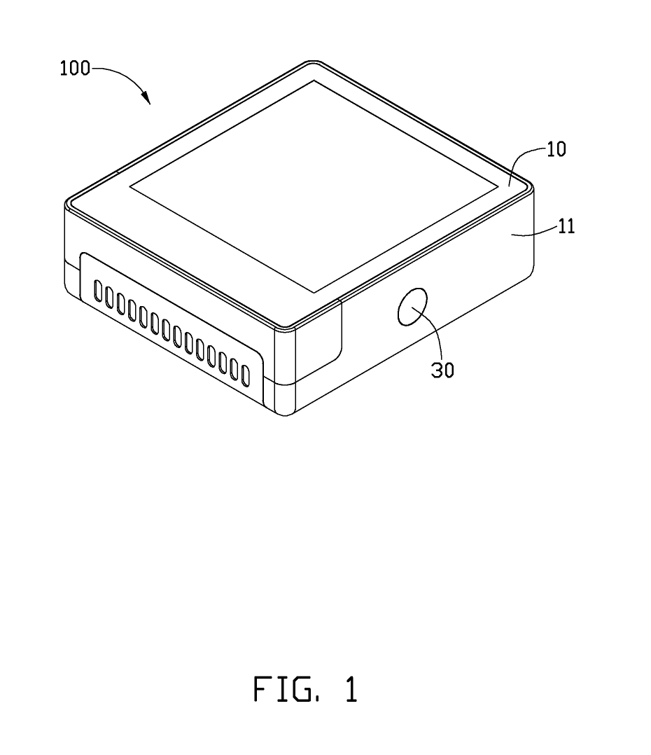

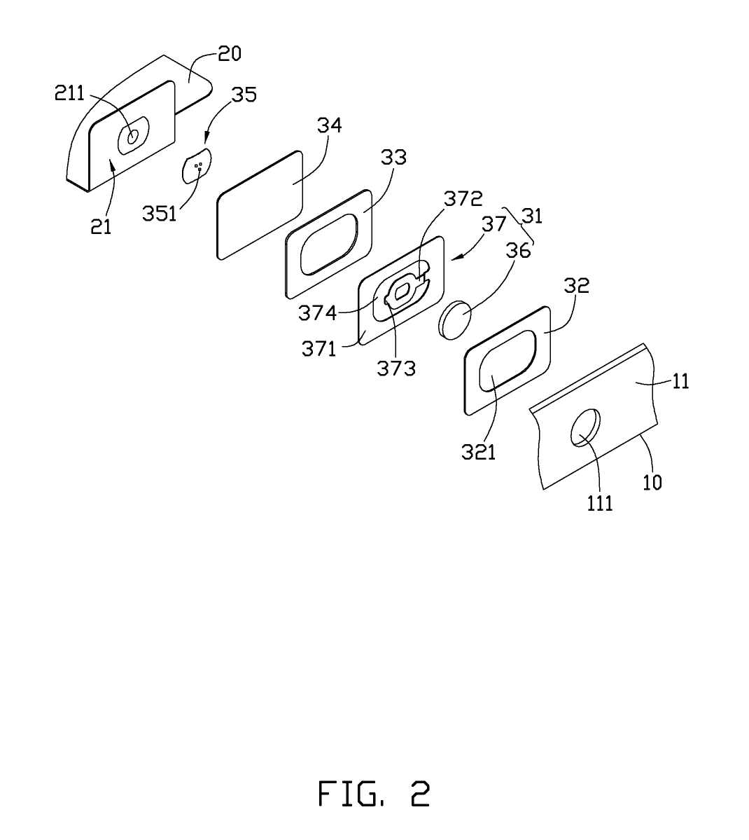

Referring to FIGS. 1-2, an electronic device 100 includes a housing 10, a printed circuit board (PCB) 20, and a button assembly 30. The electronic device 100 can be, for example, a notebook computer, a cell phone, an e-book, or a portable music player. In the embodiment, the electronic device 100 is a portable music player. The PCB 20 is fixed in the housing 10. The button assembly 30 is partially received in the housing 10.

The housing 10 includes a sidewall 11 defining a through hole 111. A portion of the button assembly 30 extends through the through hole 111. The PCB 20 includes a soldering pad 21. The soldering pad 21 includes an inner pad 211. The inner pad 211 is covered with conductive material.

The button assembly 30 includes a button 31, a first sealing frame 32, a second sealing frame 33, a sticking layer 34, and a switch 35. The button 31 includes a button body 36 and a plate 37. The button body 36 is attached to the plate 37. In the embodiment, the button body 36 is a flat cylinder. The button body 36 extends through the through hole 111 and is exposed outside the housing 10 to be operated by a user. The plate 37 provides a rebounding force to return the button body 36 to a default position.

In the embodiment, the plate 37 includes a base plate 371, a connecting member 372, and a positioning member 373. The base plate 371 defines a through hole 374. The connecting member 372 and the positioning member 373 are arranged within the through hole 374, extending from an edge of the through hole 374. One end of the connecting member 372 is fixed to the base plate 371, and the opposite end of the connecting member 372 is attached to the positioning member 373. The positioning member 373 is thus cantilevered to the base plate 371. The button body 36 is attached to the positioning member 373. When the button body 36 is depressed, the positioning member 373 moves inward, causing the connecting member 372 to deform to provide a rebound force to the positioning member 373. In other embodiments, the plate 37 may be made of elastic material.

The first sealing frame 32 and the second sealing frame 33 have the same structure. The first sealing frame 32 is double-faced adhesive tapes. The first sealing frame 32 defines a through hole 321. The size of the through hole 321 matches that of the button body 36, allowing the button body 36 to extend through the through hole 111. One side of the first sealing frame 32 is stuck to the sidewall 11, and the opposite side of the first sealing frame 32 is stuck to the plate 37. One side of the second sealing frame 33 is stuck to the plate 37, and the opposite side of the second sealing frame 33 is stuck to the sticking layer 34.

The sticking layer 34 is configured to stick the switch 35 to the PCB 20. In the embodiment, the sticking layer 34 is made of waterproof and Mylar material, the size of the sticking layer 34 matches that of the second sealing frame 33. The sticking layer 34 is used to prevent moisture penetrating the housing 10 through the through hole 111.

In the embodiment, the switch 35 is metal dome-shaped. The switch 35 includes a plurality of contacts 351. In the default position, the contacts 351 are spaced from the inner pad 211. When the keypad 36 is pressed against the switch 35, the contacts 351 of the switch 35 are connected to the inner pad 211. The switch 35 generates a signal. When the exterior force is released, the switch 35 returns to the default position.

Referring to FIG. 5, to assemble the button assembly 30, the switch 35 is attached to the PCB 20 by the sticking layer 34. One side of the first sealing frame 32 is stuck to the sidewall 11. The plate 37 is connected to the first sealing frame 32, with the button body 36 extending through the through hole 321 of the first sealing frame 32 and the through hole 111 of the housing 10, and extended partially out of the housing 10. One side of the second sealing frame 33 is stuck to the plate 37, and the opposite side of the second sealing frame 33 is stuck to the sticking layer 34, causing the first sealing frame 32 to seal a portion of the housing 10 defining the through hole 111 and the plate 37, the second sealing frame 33 to seal the plate 37 and the sticking layer 34.

When pressed, the button body 36 moves inward to actuate the switch 35, and the switch 35 generates a corresponding signal. When the exterior force operating on the button body 36 is released, the button body 36 is urged by the rebound force of the plate 37 and returns to the default position.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic device comprising:
a housing defining a through hole; and
a button assembly comprising a button, a first sealing frame, a second sealing frame, and a sticking layer, the button comprising a button body and a plate, the button body being attached to the plate, the button body extending through the through hole and being exposed outside the housing, the plate being configured to provide a rebounding force to the button body, the first sealing frame, the second sealing frame and the sticking layer being made of waterproof material, the first sealing frame sealing a portion of the housing defining the through hole and the plate, the second sealing frame sealing the plate and the sticking layer, the sticking layer covering the through hole and preventing moisture penetrating the housing through the through hole.

2. The electronic device as described in claim 1, wherein the plate is made of elastic material.

3. The electronic device as described in claim 1, wherein the plate comprises a base plate, a connecting member, and a positioning member, one end of the connecting member is attached to the base plate, the opposite end of the connecting member is attached to the positioning member, the positioning member is cantilevered to the base plate, the keypad is attached to the positioning member.

4. The electronic device as described in claim 3, wherein the base plate defines a through hole receiving the connecting member and the positioning member, and the connecting member extends from an edge of the though hole of the base plate.

5. The electronic device as described in claim 1, further comprising a switch and a PCB, wherein the switch is stuck to the PCB by the sticking layer, the switch comprises a plurality of contacts, the PCB comprises an inner pad, the inner pad is covered with conductive material, the contacts are spaced from the inner pad in a default position, when the switch is pushed by the button assembly, the contacts are connected to the inner pad.

6. The electronic device as described in claim 5, wherein the switch is metal dome-shaped.

7. The electronic device as described in claim 1, wherein the sticking layer is made of Mylar material.

8. The electronic device as described in claim 1, wherein the first sealing frame and the second sealing frame have the same structure, the first sealing frame and the second sealing frame are double-faced adhesive tapes.
